(19) United States
(12) Patent Application Publication
(10) Pub. No.: US 2021/0302795 A1
(43) Pub. Date: Sep. 30, 2021

(54) DISPLAY PANEL AND MANUFACTURING METHOD THEREOF

(71) Applicant: TCL CHINA STAR OPTOELECTRONICS TECHNOLOGY CO., LTD., Shenzhen (CN)

(72) Inventor: Qingyong ZHU, (US)

(73) Assignee: TCL CHINA STAR OPTOELECTRONICS TECHNOLOGY CO., LTD., Shenzhen (CN)

(21) Appl. No.: 16/619,469

(22) PCT Filed: Nov. 13, 2019
(86) PCT No.: PCT/CN2019/117949

§ 371 Date: Dec. 5, 2019

(30) Foreign Application Priority Data
Jul. 31, 2019 (CN) 201910701428.1

(51) Int. Cl. G02F 1/1362; G02F 1/1368; G02F 1/1335; G02F 1/1343; G02F 1/1341; G02F 1/1339

(52) U.S. Cl. CPC G02F 1/136222; G02F 1/1368; G02F 1/13394; G02F 1/134309; G02F 1/1341; G02F 1/133512

(57) ABSTRACT

A display panel comprises a first substrate, a second substrate, and a liquid crystal layer. A thin film transistor layer, a color resist layer, a polymer film on array (PFA) layer, a first electrode layer, and a spacer are disposed on the first substrate in sequence, a trench is disposed on the PFA layer and the first electrode layer, and the spacer is disposed in the trench. It can prevent the problem of the PFA layer affecting elasticity of the spacer, thereby improving products having bubbles under a high altitude and low pressure environment by opening the trench in the PFA layer that avoiding the spacer being superimposed on the PFA.

### FIELD OF INVENTION

The present disclosure relates to the field of display technologies, and more particularly, to a display panel and a manufacturing method thereof.

### BACKGROUND OF INVENTION

In color filter on array (COA) products of liquid crystal display panels, a passivation protective layer is covered on a color resist. However, the passivation protective layer needs to be formed through multiple processes, such as film formation, exposure, development, etching, and stripping. In current technology, using polymer film on array (PFA) process to substitute the passivation protective layer not only can omit the film formation and stripping processes, but also can flatten the color resist surface, providing a flat surface, and facilitating subsequent processes.

Photo spacer (PS) film columns are key materials used to fix and support thicknesses of liquid crystals in liquid crystal display panels, provide a uniform box thickness for the color filter substrate and the array substrate, and have a predetermined elasticity to prevent bubbles caused by thermal expansion and contraction of liquid crystals in the box or nonuniform distribution, and to prevent bubbles under a high altitude and low pressure environment. However, because the PFA film layer is an organic polymer material in general, it will affect the elasticity of the above layer PS film columns when it collapses or rebounds under pressure.

In summary, When the PS film columns are superimposed on the PFA film layer, the PFA film layer will affect the mechanical properties, such as the elasticity of the PS film columns, thereby affecting the product yield.

### SUMMARY OF INVENTION

The present disclosure provides a display panel and a manufacturing method thereof to solve the technical problem of products having bubbles under a high altitude and low pressure environment, thereby affecting the product yield due to disposing PS film columns on the PFA film layer and the PFA film layer will affect a normal elastic range of the above layer PS film columns when it collapses or rebounds under pressure.

To solve the above problems, an embodiment of the present disclosure provides technical solutions as follows:

The present disclosure provides a display panel. The display panel comprises a first substrate, a second substrate disposed opposite to the first substrate, and a liquid crystal layer disposed between the first substrate and the second substrate. A thin film transistor layer, a color resist layer, a PFA layer, a first electrode layer, and a spacer are disposed on the first substrate in sequence, wherein a trench is disposed on the PFA layer and the first electrode layer, the spacer is disposed in the trench, a depth of the trench is greater than a film layer thickness of the PFA layer, and an opening area of the trench is greater than a cross-sectional area of the spacer.

In an embodiment of the present disclosure, the film layer thickness of the PFA layer ranges from 1 μm to 3 μm.

In an embodiment of the present disclosure, the trench is disposed on a non-pixel area of the display panel.

In an embodiment of the present disclosure, a black matrix layer and a second electrode layer are disposed on a surface of the second substrate facing the first substrate, and the black matrix layer comprises a plurality of black light-shielding blocks.

In an embodiment of the present disclosure, the color resist layer comprises a plurality of first color resists, second color resists, and third color resists distributed adjacently.

In an embodiment of the present disclosure, an orthographic projection of the black light-shielding blocks on the first substrate is disposed between two adjacent color resists of the color resist layer.

The present disclosure provides another display panel. The display panel comprises a first substrate, a second substrate, and a liquid crystal layer. A thin film transistor layer, a color resist layer, a PFA layer, a first electrode layer, and a spacer are disposed on the first substrate in sequence, the second substrate is disposed opposite to the first substrate, and the liquid crystal layer is disposed between the first substrate and the second substrate. Wherein a trench is disposed on the PFA layer and the first electrode layer, and the spacer is disposed in the trench.

In an embodiment of the present disclosure, a depth of the trench is greater than a film layer thickness of the PFA layer.

In an embodiment of the present disclosure, the film layer thickness of the PFA layer ranges from 1 μm to 3 μm.

In an embodiment of the present disclosure, an opening area of the trench is greater than a cross-sectional area of the spacer.

In an embodiment of the present disclosure, the trench is disposed on a non-pixel area of the display panel.

In an embodiment of the present disclosure, a black matrix layer and a second electrode layer are disposed on a surface of the second substrate facing the first substrate, and the black matrix layer comprises a plurality of black light-shielding blocks.

In an embodiment of the present disclosure, the color resist layer comprises a plurality of first color resists, second color resists, and third color resists distributed adjacently.

In an embodiment of the present disclosure, an orthographic projection of the black light-shielding blocks on the first substrate is disposed between two adjacent color resists of the color resist layer.

The present disclosure further provides a manufacturing method of a display panel. The manufacturing method comprises following steps:

S10: providing a first substrate and forming a thin film transistor layer, a color resist layer, a PFA layer, and a first electrode layer on the first substrate in sequence;

S20: exposing, developing, and etching the PFA layer and the first electrode layer and forming a trench on the first substrate;

S30: forming a patterned spacer in the trench;

S40: providing a second substrate and forming a black matrix layer and a second electrode layer on the second substrate in sequence; and

S50: bonding the first substrate and the second substrate correspondingly and instillating a liquid crystal between the first substrate and the second substrate.

In an embodiment of the present disclosure, a depth of the trench is greater than a film layer thickness of the PFA layer.

In an embodiment of the present disclosure, an opening area of the trench is greater than a cross-sectional area of the spacer.

In an embodiment of the present disclosure, the trench exposes a partial surface of the color resist layer and a bottom of the spacer is in contact with a surface of the color resist layer.

In an embodiment of the present disclosure, the color resist layer comprises a plurality of first color resists, second color resists, and third color resists distributed adjacently.

In an embodiment of the present disclosure, the black matrix layer comprises black light-shielding blocks distributed in an array and an orthographic projection of the black light-shielding blocks on the first substrate is disposed between two adjacent color resists of the color resist layer.

The beneficial effect of the present disclosure is that It can prevent the problem of the PFA layer affecting elasticity of the spacer, thereby improving products having bubbles under a high altitude and low pressure environment by opening the trench in the PFA layer and disposing the spacer in the trench that avoiding the spacer being superimposed on the PFA.

### DESCRIPTION OF DRAWINGS

The accompanying figures to be used in the description of embodiments of the present disclosure or prior art will be described in brief to more clearly illustrate the technical solutions of the embodiments or the prior art. The accompanying figures described below are only part of the embodiments of the present disclosure, from which those skilled in the art can derive further figures without making any inventive efforts.

FIG. 1 is a schematic structural diagram of a display panel according to an embodiment of the present disclosure.

FIG. 2 to FIG. 4 are schematic structural diagram of a display panel in a manufacturing process according to an embodiment of the present disclosure.

FIG. 5 is a flowchart of a manufacturing method of a display panel according to an embodiment of the present disclosure.

### DETAILED DESCRIPTION OF PREFERRED EMBODIMENTS

The embodiments of the present disclosure are described in detail hereinafter. Examples of the described embodiments are given in the accompanying drawings, wherein the identical or similar reference numerals constantly denote the identical or similar elements or elements having the identical or similar functions. In the description of the present disclosure, it should be understood that terms such as “upper”, “lower”, “front”, “rear”, “left”, “right”, “inside”, “outside”, “side”, as well as derivative thereof should be construed to refer to the orientation as described or as shown in the drawings under discussion. These relative terms are for convenience of description, do not require that the present disclosure be constructed or operated in a particular orientation, and shall not be construed as causing limitations to the present disclosure.

An embodiment of the present disclosure provides a solution for a defect in current display panel. The defect is that products have bubbles under a high altitude and low pressure environment, thereby affecting the product yield due to disposing PS film columns on the PFA film layer and the PFA film layer affecting a normal elastic range of the above layer PS film columns when it collapses or rebounds under pressure.

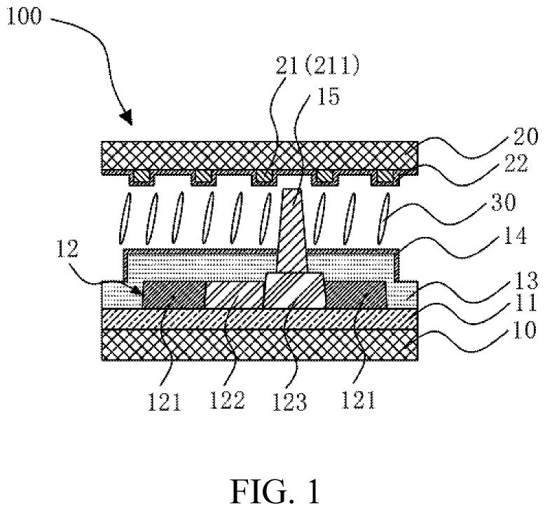

As shown in FIG. 1, an embodiment of the present disclosure provides a display panel 100. The display panel 100 comprises a first substrate 10, a second substrate 20 disposed opposite to the first substrate 10, and a liquid crystal layer 30 disposed between the first substrate 10 and the second substrate 20.

A thin film transistor layer 11 is disposed on one side of the first substrate 10 facing the second substrate 20, a color resist layer 12 is disposed on the thin film transistor layer 11, the color resist layer 12 is covered with a PFA layer 13, and a first electrode layer 14 and a spacer 15 are disposed on the PFA layer 13.

A black matrix layer 21 is disposed on one side of the second substrate 20 facing the first substrate 10, a second electrode layer 22 is disposed on the second substrate 20 and the black matrix layer 21, the second electrode layer 22 is disposed opposite to the first electrode layer 14, and the liquid crystal layer 30 is disposed between the second electrode layer 22 and the first electrode layer 14.

A material of the PFA layer 13 is an organic polymer material which provides a flat terrain for subsequent processes and improves coating property for subsequent processes. Because the spacer 15 can support a predetermined height between the first substrate 10 and the second substrate 20, maintain a uniform cell gap at each location, and has a predetermined elasticity to prevent bubbles caused by thermal expansion and contraction of liquid crystals in the box or bubbles caused under a high altitude and low pressure environment, the spacer 15 is disposed on the PFA layer 13. When the PFA layer 13 collapses or rebounds under pressure, it will affect a normal elastic range of the above layer of the spacer 15, thereby causing poor phenomenon of products having bubbles under a high altitude and low pressure environment. This embodiment improves the relative positions of the PFA layer 13 and the spacer 15, thereby preventing the unfavorable influence to the spacer 15 caused by the PFA layer 13 due to its own characteristics.

Specifically, as shown in FIG. 3, a trench 101 is disposed on the PFA layer 13 and the first electrode layer 14, the spacer 15 is disposed in the trench 101.

The trench 101 penetrates the PFA layer 13 and the first electrode layer 14, thereby avoiding the spacer 15 being superimposed on the PFA layer 13 and preventing affecting elasticity of the spacer 15 caused by the PFA layer 13.

The trench 101 is disposed in a non-pixel area and avoiding an effective display area of the display panel 100, thereby not affecting normal display properties.

By processes of exposing, developing, and etching the PFA layer at a position corresponding to the spacer 15 and forming the trench 101 at the corresponding position. The trench 101 penetrates the PFA layer 13 in the thickness direction of the PFA layer 13, making the bottom of the spacer 15 which is subsequently manufactured in the trench 101 not in contact with the PFA layer 13 and in contact with the lower color resist layer 12, thereby preventing the spacer 15 standing on the PFA layer and affecting characteristics, such as elastic resilience of the spacer 15.

The film thickness of the PFA layer 13 ranges from 1 μm to 3 μm, and the depth of the trench 101 is greater than the thickness of the PFA layer 13, making the subsequently manufactured spacer 15 stably standing in the trench 101. In other embodiments, the depth of the trench 101 can extend to a color resist of the lower color resist layer 12 depending on actual needs, that is partial slotting on the lower corresponding color resist layer 12 to increase the depth of the trench 101.

Because the first electrode layer 14 is disposed on the PFA layer 13, the first electrode layer 14 needs to be exposed, developed, and etched, thereby forming the trench 101 on the first electrode layer 14 and the PFA layer.

To make the spacer 15 easier to be manufactured in the trench 101, an opening area of the trench 101 is greater than a cross-sectional area of any portion of the spacer 15. The cross section of the spacer 15 may be trapezoidal, square, circular, etc., and the shape of the spacer 15 is not limited herein.

The first electrode layer 14 can be a pixel electrode layer, and the second electrode layer 22 can be a common electrode layer.

The color resist layer includes a plurality of adjacently disposed first color resists 121, second color resists 122, and third color resists 123, wherein the first color resists 121, the second color resists 122, and the third color resists 123 are respectively one of a red color resist, a green color resist, and a blue color resist. In the embodiment, the first color resist 121 is a red color resist, the second color resist 122 is a green color resist, and the third color resist 123 is a blue color resist.

The black matrix layer 21 comprises black light-shielding blocks 211 distributed in an array and an orthographic projection of the black light-shielding blocks 211 on the first substrate 10 is disposed between two adjacent color resists of the color resist layer 12. The black light-shielding blocks 211 are used to block gaps between the adjacent color resists to prevent light leakage or color mixture, thereby improving display contrast.

The first substrate 10 and the second substrate 20 are both glass substrates, and may be other transparent substrates, which are not limited herein. The thin film transistor layer 11 comprises a plurality of thin film transistors distributed in an array (not shown in the figure). Because the thin film transistors shield partial light, the thin film transistors need to be disposed in a light-shielding area of the display panel 100. An orthographic projection of the thin film transistors on the first substrate 10 is disposed between adjacent color resists of the color resist layer 12.

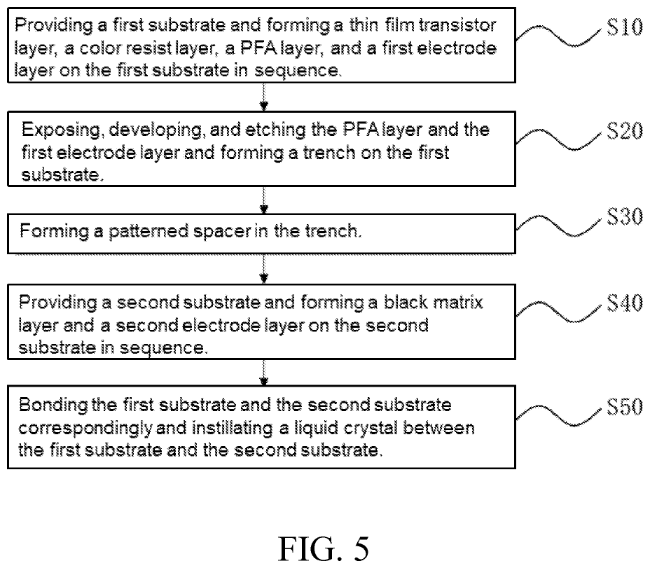

As shown in FIG. 5, an embodiment of the present disclosure further provides a manufacturing method of the above display panel 100. The manufacturing method comprises the following steps:

S10: providing the first substrate 10 and forming the thin film transistor layer 11, the color resist layer 12, the PFA layer 13, and the first electrode layer 14 on the first substrate 10 in sequence.

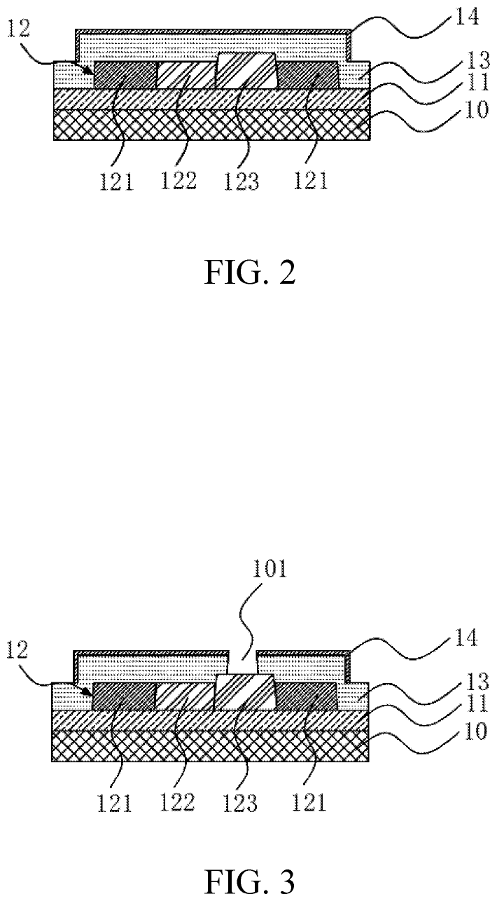

As shown in FIG. 2, the thin film transistor layer 11 includes a gate electrode, a source/drain electrode, an active layer, a data line, and a scanning line. The first color resists 121, the second color resists 122, and the third color resists 123 are formed in separate regions on the thin film transistor layer 11, then the color resist layer 12 is covered with the PFA layer 13, and at last, the first electrode layer 14 is manufactured on the PFA layer 13.

S20: exposing, developing, and etching the PFA layer 13 and the first electrode layer 14 and forming the trench 101 on the first substrate 10.

As shown in FIG. 3, first, perform a mask process on the first electrode layer 14 to form an opening, then perform a mask process on the PFA layer 13 under the opening, and at last, form the trench 101. The trench 101 exposes a partial surface of the color resist layer 12, can perform a mask process on the PFA layer 13 when forming the PFA film layer, and after that, form the first electrode layer 14.

S30: forming a patterned spacer 15 in the trench 101.

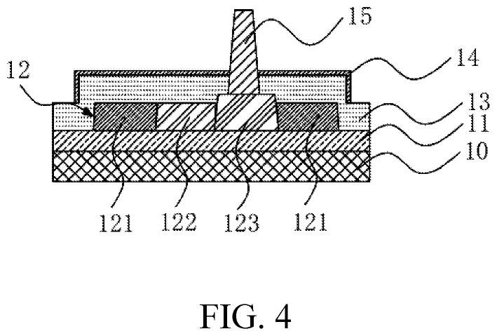

As shown in FIG. 4, the bottom of the spacer 15 is in contact with a surface of the color resist layer 12, avoiding the spacer 15 being superimposed on the PFA layer 13.

S40: providing the second substrate 20 and forming the black matrix layer 21 and the second electrode layer 22 on the second substrate 20 in sequence.

First, form an array of distributed black light-shielding blocks 211 on the second substrate 20, and after that, form the second electrode layer 22 on the second substrate 20 and the black light-shielding blocks 211.

S50: bonding the first substrate 10 and the second substrate 20 correspondingly and instillating a liquid crystal between the first substrate 10 and the second substrate 20.

One side of the first substrate 10 having the spacer 15 is attached to one side of the second substrate 20 having the black matrix layer 21.

The beneficial effect: it can prevent the problem of the PFA layer affecting elasticity of the spacer, thereby improving products having bubbles under a high altitude and low pressure environment by opening the trench in the PFA layer and disposing the spacer in the trench that avoiding the spacer being superimposed on the PFA.

The present disclosure has been described with a preferred embodiment thereof. The preferred embodiment is not intended to limit the present disclosure, and it is understood that many changes and modifications to the described embodiment can be carried out without departing from the scope and the spirit of the disclosure that is intended to be limited only by the appended claims.

What is claimed is:

1. A display panel, comprising:
a first substrate, wherein the first substrate is provided with a thin film transistor layer, a color resist layer, a polymer film on array (PFA) layer, a first electrode layer, and a spacer disposed in sequence;
a second substrate disposed opposite to the first substrate; and
a liquid crystal layer disposed between the first substrate and the second substrate;
wherein a trench is disposed on the PFA layer and the first electrode layer, the spacer is disposed in the trench, a depth of the trench is greater than a film layer thickness of the PFA layer, and an opening area of the trench is greater than a cross-sectional area of the spacer.

2. The display panel according to claim 1, wherein the film layer thickness of the PFA layer ranges from 1 μm to 3 μm.

3. The display panel according to claim 1, wherein the trench is disposed on a non-pixel area of the display panel.

4. The display panel according to claim 1, wherein a black matrix layer and a second electrode layer are disposed on a surface of the second substrate facing the first substrate, and the black matrix layer comprises a plurality of black light-shielding blocks.

5. The display panel according to claim 4, wherein the color resist layer comprises a plurality of first color resists, second color resists, and third color resists distributed adjacently.

6. The display panel according to claim 5, wherein an orthographic projection of the black light-shielding blocks on the first substrate is disposed between two adjacent color resists of the color resist layer.

7. A display panel, comprising:
a first substrate, wherein the first substrate is provided with a thin film transistor layer, a color resist layer, a polymer film on array (PFA) layer, a first electrode layer, and a spacer disposed in sequence;
a second substrate disposed opposite to the first substrate; and
a liquid crystal layer disposed between the first substrate and the second substrate;
wherein a trench is disposed on the PFA layer and the first electrode layer, the spacer is disposed in the trench.

8. The display panel according to claim 7, wherein a depth of the trench is greater than a film layer thickness of the PFA layer.

9. The display panel according to claim 8, wherein the film layer thickness of the PFA layer ranges from 1 μm to 3 μm.

10. The display panel according to claim 7, wherein an opening area of the trench is greater than a cross-sectional area of the spacer.

11. The display panel according to claim 7, wherein the trench is disposed on a non-pixel area of the display panel.

12. The display panel according to claim 7, wherein a black matrix layer and a second electrode layer are disposed on a surface of the second substrate facing the first substrate, and the black matrix layer comprises a plurality of black light-shielding blocks.

13. The display panel according to claim 12, wherein the color resist layer comprises a plurality of first color resists, second color resists, and third color resists distributed adjacently.

14. The display panel according to claim 13, wherein an orthographic projection of the black light-shielding blocks on the first substrate is disposed between two adjacent color resists of the color resist layer.

15. A manufacturing method of a display panel, comprising following steps:
S10: providing a first substrate and forming a thin film transistor layer, a color resist layer, a polymer film on array (PFA) layer, and a first electrode layer on the first substrate in sequence;
S20: exposing, developing, and etching the PFA layer and the first electrode layer and forming a trench on the first substrate;
S30: forming a patterned spacer in the trench;
S40: providing a second substrate and forming a black matrix layer and a second electrode layer on the second substrate in sequence; and
S50: bonding the first substrate and the second substrate correspondingly and instillating a liquid crystal between the first substrate and the second substrate.

16. The manufacturing method according to claim 15, wherein a depth of the trench is greater than a film layer thickness of the PFA layer.

17. The manufacturing method according to claim 15, wherein an opening area of the trench is greater than a cross-sectional area of the spacer.

18. The manufacturing method according to claim 15, wherein the trench exposes a partial surface of the color resist layer and a bottom of the spacer is in contact with a surface of the color resist layer.

19. The manufacturing method according to claim 15, wherein the color resist layer comprises a plurality of first color resists, second color resists, and third color resists distributed adjacently.

20. The manufacturing method according to claim 19, wherein the black matrix layer comprises black light-shielding blocks distributed in an array and an orthographic projection of the black light-shielding blocks on the first substrate is disposed between two adjacent color resists of the color resist layer.
